(19) United States
(12) Patent Application Publication
(10) Pub. No.: US 2019/0043094 A1
(43) Pub. Date: Feb. 7, 2019

(54) PRESENTING A CONTENT ITEM TO AN ONLINE SYSTEM USER INCLUDING CONTENT DYNAMICALLY GENERATED BY THE ONLINE SYSTEM FOR THE USER

(71) Applicant: Facebook, Inc., Menlo Park, CA (US)

(72) Inventor: Leonid Litvak, Santa Clara, CA (US)

(21) Appl. No.: 15/668,654

(22) Filed: Aug. 3, 2017

(51) Int. Cl. G06Q 30/02

(52) U.S. Cl. CPC G06Q 30/0276; G06Q 30/0283; G06Q 30/0255

(57) ABSTRACT

An online system receives a content item for a product that includes a creative with placeholder components that are replaceable with information describing the product. A goal is associated with presentation of the product which the online system uses to determine a price for the product for each user at the time the content item is presented to the user. Using the goal, the online system determines a price of the product for the user based on the goal and a determined likelihood of the user interacting with the content item for the product and replaces a placeholder component of the creative for the content item with a price component. The online system then provides the content item including the creative describing the product with an offer to purchase the product at the determined price for the product for display to the user.

### BACKGROUND

This disclosure relates generally to presenting content to users of an online system, and more specifically to generating a content item including content describing a product selected by the online system for presentation to the user.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

Various publishing users or third party systems may provide the online system with content items identifying products associated with the publishing users or third party systems, such as products a publishing user or a third party system offers for sale. However, different users may have varying levels of interest in different products associated with a publishing user or a third party system. For example, where various products are offered for sale by a publishing user, if the publishing user selects content about a particular product for inclusion in a content item, users who are uninterested in the particular product may be less inclined to view or to interact with the content item. In the preceding example, if information about an alternative product were included in the content item, different users may be more inclined to view or to otherwise interact with the content item. While a publishing user generating multiple content items including content describing different products and providing the multiple content items to the online system for presentation may increase a number of online system users who view or who interact with content items provided by the publishing user to the online system, generating and maintaining a large number of content items consumes significant resources and time of a publishing user.

### SUMMARY

An online system dynamically determines an optimal price specific to a given user for a product in a content item of a content provider designed to allow the content provider to meet a goal or objective associated with the content item. The online system receives a content item for presentation to one or more users of the online system that includes a creative presenting content from an application that includes a product. The content item is associated with a goal and one or more constraints and the creative includes one or more placeholder components that are replaceable with information describing the product. The goal is associated with presentation of the product from the third party system that allows the online system flexibility to dynamically determine a price for the product for each individual user at the time the content item describing the product is presented to the user. Using the goal and one or more constraints, the online system determines an optimal price for the product being described in the content item to allow the third party system to meet the specified goal. In response to identifying the opportunity to present the content item, the online system accessing product engagement data for the user and determines a likelihood of the user interacting with the content item for the product based on the accessed product engagement data for the user identifying the previously accessed products of the user. Thus, in one embodiment, the optimal price is determined as a function of a probability of a particular user selecting the content item describing the product based on the user's engagement with other similar products. In addition to the product engagement data, the online system may consider one or more of following when determining the probability: product attributes (e.g., expensive product may allow for a longer consideration cycle), price sensitivity (e.g., high price sensitivity for cheaper products relative to more expense products), time of day of the presentation opportunity, the particular user to whom the content item is being presented to (per impression based dynamic pricing), and user features and engagement data (e.g., past purchases, user's affinity for the product, how many times have they seen the content item, has the user seen the content item and x-ed it out before, pixel fires, etc.).

The online system uses this information to determine a likelihood of the user selecting or converting on the content item and determines the optimal price for the product based on the likelihood of conversion and the goal of the third party system for the ad campaign. In one embodiment, the online system sets its own goal for the ad campaign and builds this additional goal into the determined optimal price. For example, the additional goal could be an additional percent markup of the offered price of the product as compensation for presenting the content item to users of the online system. Accordingly, the online system determines a price for the product for the user based on the goal, the one or more constraints, and the determined likelihood of the user interacting with the content item for the product and replaces a placeholder component of the creative for the content item with a price component. The online system then provides the content item including the creative describing the product with an offer to purchase the product at the determined optimal price for the product for display to the user. The price for the product shown in the content item displayed to the user is, thus, individually adjusted for each user based on user features and engagement data to optimize the conversion rate of the content item. Accordingly, the online system receives an interaction with the content item corresponding to the user selecting the offer to purchase the product at the determined optimal price via the content item. In response to receiving the interaction to the content item, the online system sends the user and offer data corresponding to the determined optimal price for the product to a landing page for the product at the third party system. In one embodiment, the landing page at the third party system displays the offer to purchase the product at the optimal price determined by the online system. Accordingly, when the user is sent to the landing page of the third party system, the third party system updates the price for the product display on the landing page for the product based on the offer data received from the online system.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a conceptual diagram of generation of a content item generated for a user by an online system based on products accessed by the user, in accordance with an embodiment.

FIG. 4A is a flowchart of a method for adjusting a score of a content item in a selection process for presentation to a user of the online system based on a determined competitiveness of a price for a product associated with the content item relative a price for the product being offered by other third party systems, in accordance with an embodiment.

FIG. 4B is a product price comparison diagram that can be displayed to a third party system user, in accordance with an embodiment.

FIG. 5 is a flowchart of a method for determining a price for a product based on a user of the online system being presented a content item describing the product, in accordance with an embodiment.

FIG. 6 is a flowchart of a method for determining an offer format to present to a user in a content item for a product based on past engagement of the user with content items having one or more different offer formats, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

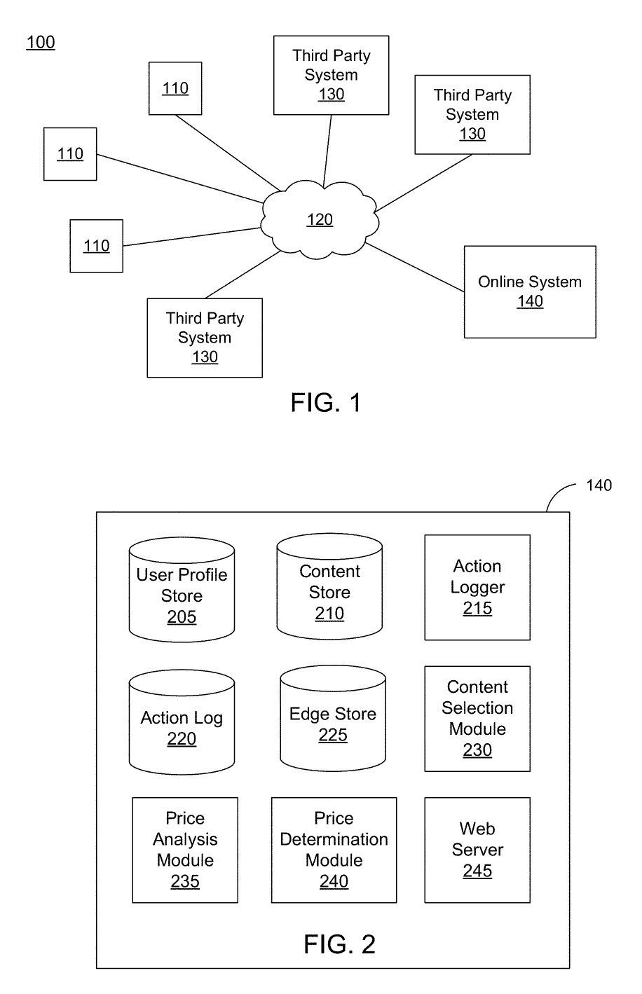

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

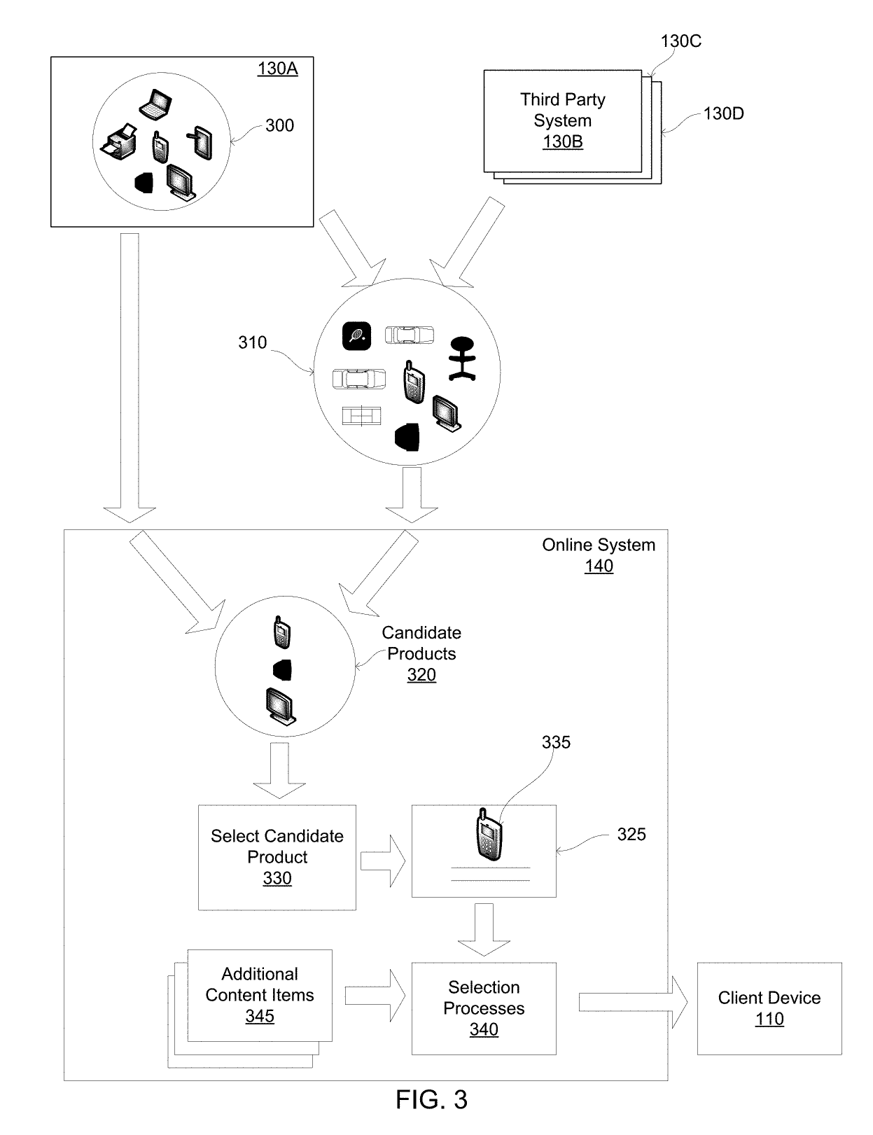

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, price analysis module 235, price determination module 240, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third party applications or third party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include a creative and a bid amount. The creative includes content for presentation to a user, such as text, image, audio, video, or any other suitable data presented to a user. In various embodiments, the creative also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with content items and advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements or other content with which the user engaged, purchases made, and other patterns from shopping and buying. Hence, the action log 220 may include information identifying content provided by one or more third party systems 130 that a user of the online system 140 has accessed or content provided by one or more third party systems 130 with which the user of the online system 140 otherwise interacted. Various third party systems 130 may include tracking mechanisms (e.g., a tracking pixel) in content comprising instructions that, when executed by a client device 110, provide information identifying the content and identifying a user of the online system 140 associated with the client device 110 to the online system 140. In various embodiments, the information provided by the tracking mechanism identifies one or more products associated with a third party system 130 and include in, or otherwise associated with, the identified content. The information identifying the content is stored in the action log 220 in association with information identifying the user to the online system 140. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items that are not associated with bid amounts, such as stories describing actions associated with other online system users connected to the user. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

In various embodiments, the content selection module 230 also maintains information describing various products and selects a product for a user of the online system 140. For example, various third party systems 130 provide information to the content selection module 230 specifying characteristics of various products associated with the third party systems 130. As an example, a third party system 130 provides information to the content selection module 230 including identifiers of products sold or maintained by the third party system 130; associated with each identifier are one or more characteristics of a product corresponding to an identifier (e.g., a description of the product, keywords associated with the product, a name of the product, dimensions of the product, reviews of the product, etc.).

In various embodiments, the content selection module 230 also maintains information describing various offer formats and selects an offer format to accompany a product being presented to a user of the online system 140. For example, for a product with an original suggested retail value of $2,000, presenting an offer for the product at $1,500, $500 off, or 25% off each correspond to the same offer or price of the product (i.e., $1,500 is $500 off $2,000 and $500 off of $2,000 is 25% off of $2,000). Accordingly, $1,500, $500 off, and 25% off each correspond to a different offer format. Since different users may have a different affinity for a different offer format, the offer format for presentation in a content item can be determined at presentation time for each individual user based on engagement data (e.g., the offer formats associated with past purchases, the offer formats associated with past content item engagement, whether the user x-ed out a content with a specific offer format more frequently than other offer formats, etc.). Thus, at the time the selected content item is presented to the user, the format of the offer or price shown in the content item can be dynamically adjusted for the user based on engagement data.

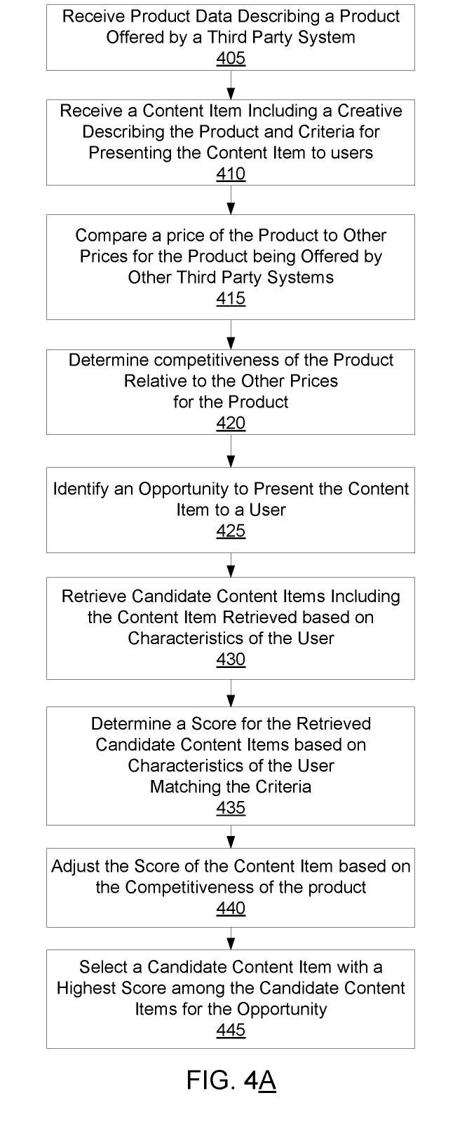

Based on information included in the action log 220 identifying content accessed by a user, the content selection module 230 selects candidate products from the maintained information for the user. In some embodiments, the content selection module 230 selects candidate products from the maintained information that were included in previously content accessed by the user or selects a product from the maintained information that was previously accessed by the user. For example, the content selection module 230 selects candidate products as products that were described or otherwise included in at least a threshold amount of content accessed by the user. In another embodiment, the content selection module 230 selects candidate products as products that were previously accessed by the user, such as a product that was previously accessed by a user at least a threshold number of times or a product that was previously accessed by user within a threshold amount of time from a time when the content selection module 230 selects the product. In other embodiments, the content selection module 230 selects candidate products based on characteristics of various products from the maintained information matching characteristics of content accessed by the user or matching characteristics of products accessed by the user. For example, the content selection module 230 ranks products based on percentages of characteristics of the products matching characteristics of content accessed by the user and selects candidate products as products having a least a threshold position in the ranking. In another example, the content selection module 230 ranks products based on percentages or other amounts of characteristics of the products matching characteristics of products previously accessed by the user. The content selection module 230 may account for other users of the online system 140 who accessed various products when selecting candidate products product for the user in various embodiments, as further described below in conjunction with FIG. 3.

As further described below in conjunction with FIG. 3, the content selection module 230 determines likelihoods of the user interacting with content items including different candidate products. The content selection module 230 selects a candidate product based on the determined likelihoods and generates the creative of the content item so the creative includes content describing the selected product. After generating the creative of the content item, the content selection module 230 includes the content item with the content describing the selected product in one or more selection processes selecting content for presentation to the user. For example, the content selection module 230 includes an image and a name of the selected product in the creative of the content item. However, in other embodiments, the content selection module 230 includes any suitable content describing the selected product from the third party system 130 associated with the selected product or from information about the selected product maintained by the online system 140. As further described above, the one or more selection processes select content form the content item having the content describing the selected product and other content items and communicate the selected content to a client device 110 associated with the user for presentation. Selecting content and generating a content item for a product selected by the online system 140 based on a template content item that includes placeholder or default values for one or more components of the template is further described in U.S. patent application Ser. No. 14/085,998, filed on Nov. 21, 2013, which is hereby incorporated by reference in its entirety. Selection of a product and inclusion of content describing the product in a content item is further described below in conjunction with FIG. 3.

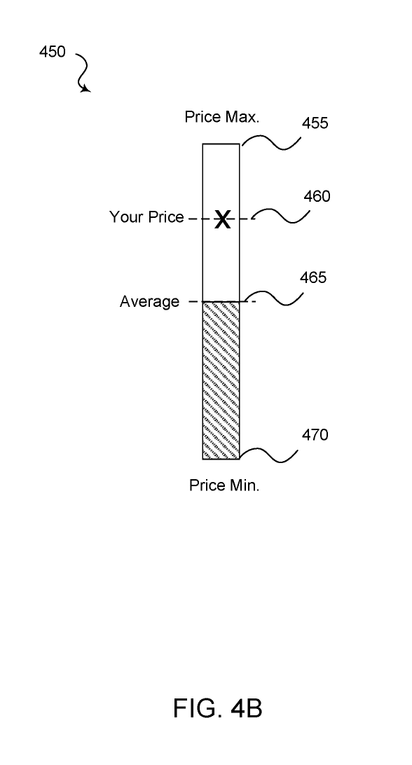

The price analysis module 235 receives price information for a product set (e.g., a product catalog, or data for different products, pricing, discounts, etc.) from a third party system 130 and compares the price information for the product set to other products from other third party systems 130 to identify similar and identical products being sold/advertised by the other third party systems 130. Price analysis module 235 performs a pricing analysis of the similar or identical products to determine how the price that each third party system 130 is offering for a product compares to the price of the product being sold/advertised by the other third party systems 130. For example, whether the price is above or below the average and/or how far a particular third party system 130 is from an average price for a product. In various embodiments, this information can be provided to the third party system 130 to allow the advertiser to adjust their prices and become more competitive. Additionally, as will further described below in conjunction with FIG. 4A, price analysis module 235 may determine a competitiveness value for the product offered by a third party system 130 relative to other third party systems 130 and provide the competitiveness value to content selection module 230 to adjust a score or ranking of the content item associated with the product. The relative competitiveness of the price of a product effects the likelihood of a user selecting a content item and, thus, selection module 230 can use this information in the content item selection process.

Price determination module 240 determines an optimal price for a product being advertised by a third party system 130. In various embodiments, the online system 140 receives a goal or objective of an ad campaign of a third party system 130 (e.g., to sell X amount of product Y or to make Z amount of money on product sales over the next month). Price determination module 240 then determines the optimal price for a product being presented to a user of the online system 140 in a content item at presentation time to allow the third party system 140 to meet the goal. Price determination module 240 may consider product attributes (e.g., expensive product, therefore a longer consideration cycle), price sensitivity (e.g., high price sensitivity for cheap items), time of day, a particular user to whom the ad will be shown (per presentation opportunity based dynamic pricing), user features and engagement data (e.g., past purchases, user's affinity for the product, how many times has a user been presented a content with the product, has the user x-ed out the content previously, pixel fires, etc.), and so forth when determining the optimal price for the user. Price determination module 240 then provides information for an optimal price for the product for incorporation into a creative for the content item. At user presentation time (e.g., impression time), the price of the product being shown in the content item is the optimal price of the product. In various embodiments, the price is adjusted based on user features and engagement data to optimize the conversion rate of the content item.

The web server 245 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, or BlackberryOS.

### Generating a Content Item for a Product Selected for a User by an Online System

FIG. 3 is a conceptual diagram of an online system 140 generating a content item for a user of the online system 140 based on products accessed by users of the online system 140. The online system 140 obtains information 300 about products associated with a third party system 130A. For example, the third party system 130A provides the online system 140 with information 300 including identifiers of various products associated with the third party system 130A, characteristics of various products associated with the third party system 130A (e.g., descriptions of products, keywords associated with products, pricing information for products, or any other suitable information). The online system 140 may periodically request the information 300 about the products from the third party system 130A. Additionally or alternatively, the third party system 130A may provide the information 300 describing products associated with the third party system 130A to the online system 140 without receiving a request from the online system 140. For example, the third party system 130A provides information 300 describing a product that is newly associated with the third party system (e.g., a product newly offered for sale by the third party system 130A). As another example, the third party system 130A periodically communicates information 300 describing products associated with the third party system 130A to the online system 140.

The online system 140 also receives information describing products 310 associated with various third party systems 130A, 130B, 130C accessed by users of the online system 140. In some embodiments, the online system 140 receives information from various third party systems 130A, 130B, 130C describing products 310 associated with the various third party systems 130A, 130B, 130B accessed by a user of the online system 140. The online system 140 may also receive information from various third party systems 130A, 130B, 130C identifying products associated with the various third party systems 130A, 130B, 130C accessed by additional users of the online system 140. While FIG. 3 shows an example where the online system 140 receives information describing products 310 associated with third party systems 130A, 130B, 130C accessed by the user, in other embodiments, the online system 140 receives information identifying content associated with various third party systems 130A, 130B, 130C accessed by the user and identifies products 310 associated with the third party systems 130A, 130B, 130C that the user accessed from the content accessed by the user. For example, various third party systems 130A, 130B, 130C include tracking mechanisms in content provided by the third party system 130A, 130B, 130C. A tracking mechanism comprises instructions that, when executed by a client device 110 presenting the content, communicate information to the online system 140 identifying one or more products 310 included in the accessed content or identifying one or more products 310 accessed by a user of the client device 110 via the presented content. Different third party systems 130A, 130B, 130C include tracking mechanisms in various content provided by the third party systems 130A, 130B, 130C to provide information to the online system 140 identifying content from the various third party systems 130A, 130B, 130C presented to the user. The online system 140 stores information identifying products 310 associated with a third party system 130A, 130B, 130C accessed by a user in association with the user and in association with the third party system 130A, 130B, 130C associated with the products 310 to maintain a log of products 310 associated with one or more third party systems 130A, 130B, 130C that the user has accessed. In other embodiments, the online system 140 may receive the information describing products 310 accessed by the user from third party systems 130A, 130B, 130C themselves or from any suitable source.

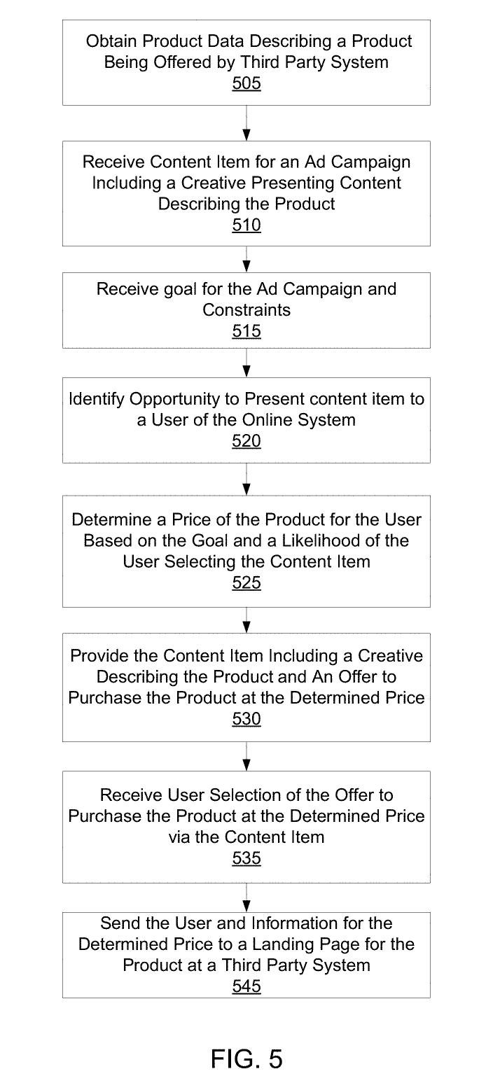

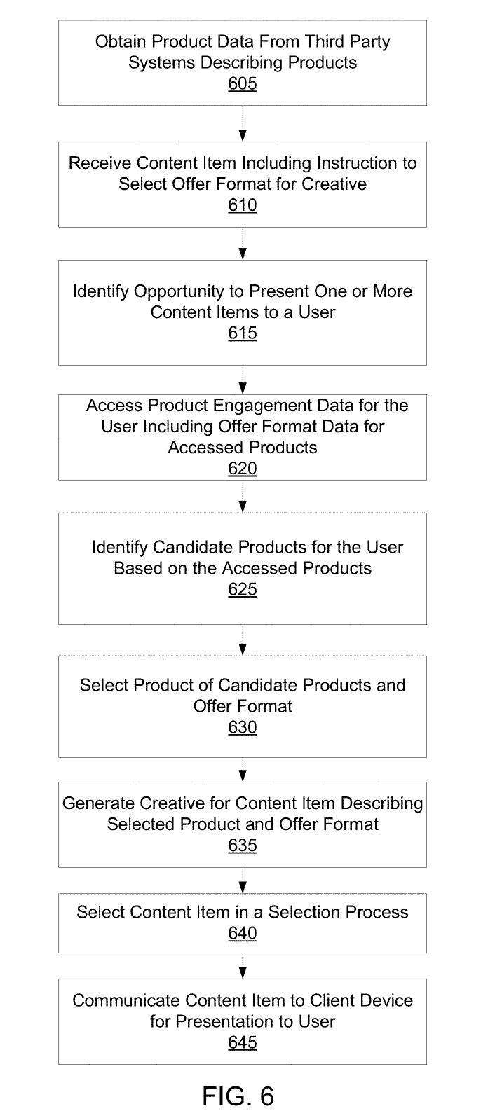

The online system 140 receives a content item associated with a third party system 130A. In various embodiments, the content item includes instructions for generating a creative of the content item that describes a product 310 associated with the third party system 130A that is selected by the online system 140. When the online system 140 identifies an opportunity to present content to a user and the content item is eligible for presentation to the user, the online system 140 identifies candidate products 320 associated with the third party system 130 based on the information 300 identifying products associated with the third party system 130A and products 310 associated with various third party systems 130A, 130B, 130C accessed by the user. In various embodiments, the instructions for generating the creative of the content item additionally cause price determination module 240 to determine a price for the product for the particular user that the content item is to be presented to, as will be further described with respect to FIG. 5. Similarly, the instructions for generating the creative of the content item may additionally, or in a different embodiment, cause content selection module 230 to select an offer format for the price of the product for the particular user, as will be further described with respect to FIG. 6.

In various embodiments, the online system 140 identifies the candidate products 320 based on products 310 associated with various third party systems 130A, 130B, 130C. For example, the online system 140 identifies candidate products 320 as products associated with the third party system 130A from the information 300 received from the third party system 130A having at least a threshold percentage of characteristics matching characteristics of products 310 identified by one or more third party systems 130A, 130B, 130C as products 310 with which the user interacted. As another example, the online system 140 identifies candidate products 320 as products associated with the third party system 130A from the information 300 received from the third party system 130A having characteristics matching characteristics of products 310 associated with third party systems 130A, 130B, 130C with which at least a threshold number of additional users interacted.

The online system 140 determines likelihoods of the user interacting with content items including content describing different candidate products 320 and selects 330 a product of the candidate products 320 based on the likelihoods. For example, the online system 140 generates multiple content items that each include content describing a different candidate product 320 and applies one or more models to the generated content items that determine a likelihood of the user interacting with each content item including content describing a candidate product 320. Alternatively, the online system 140 determines the likelihoods of the user interacting with content items based on the different candidate products 320 and a price associated with each of the different candidate products 320. As further described above, the online system 140 may rank the generated content items based on the determined likelihoods and select 330 a candidate product 320 described by information included in a generated content item having at least a threshold position in the ranking.

The online system 140 generates a creative for the content item 325 including content describing the selected product 335, which is selected from the candidate products 320 as further described above and in conjunction with FIG. 3. For example, the online system 140 generates a creative for the content item 325 including an image, a name, and a description of the selected product 335. Hence, the online system 140 dynamically generates a content for the creative of the content item 330 for presentation to the user based on products 310 associated with one or more third party systems 130A, 130B, 130C previously accessed by the user and products associated with the third party system 130 specified by the information 300 received from the third party system 130A. Thus, content item 325 may present different content to different users and have a creative including content describing a product associated with the third party system 130A that is more likely to be relevant to the user. As further described above, the online system 140 includes the content item 325 having its creative include content describing the selected product 335 in one or more selection processes 340 selecting content for presentation to the user. The selection processes 340 evaluate likelihoods of the user interacting with the content item 340 having its creative including content describing the selected product 335 and interacting with additional content items 345. In various embodiments, the online system 140 applies one or more models to characteristics of the content item 325 and to characteristics of the additional content items 345 to determine likelihoods of the user interacting with the content item 325 and with the additional content items 345. As further described above in conjunction with FIGS. 2 and 3, the online system 140 uses the determined likelihoods to select content items from the content item 325 and the additional content items 345. Hence, the online system 140 accounts for different likelihoods of the user interacting with content including different candidate products 320 when selecting content to generate the creative for the content item 325, allowing the online system 140 to populate the creative of the content item 325 with content describing a selected product 335 of the candidate products 320 with which the user is most likely to interact. Subsequently, the online system 140 evaluates likelihoods of the user interacting with the content item 325 having its creative include content describing the selected product 335 and additional content items 345 to select content for communication to a client device 110 for presentation to the user. Hence, the content communicated from the online system 140 to the client device 110 is more likely to be content with which the user interacts.

### Determining a Competitiveness Value for a Product Based on a Price Analysis and Adjusting Scores Used to Rank Content Items for Presentation to Users Based on the Determined Competitiveness Value

FIG. 4A is a flowchart of one embodiment a method for adjusting a score of a content item in a selection process for presentation to a user of the online system 140 based on a determined competitiveness of a price for a product associated with the content item being offered by a third party system 130 relative to a price for the product being offered by other third party systems 130. In other embodiments, the method may include different and/or additional steps than those shown in FIG. 4A. Additionally, steps of the method may be performed in different orders than the order described in conjunction with FIG. 4A in various embodiments.

The online system 140 receives 405 product data from a third party system 130 describing characteristics of a product being offered by the third party system 130. The product data including a price associated with the product. Various third party systems 130 provide the online system 140 with information describing products associated with the third party systems 130, such as products offered for sale or otherwise provided by the one or more third party systems 130. For example, a third party system 130 provides the online system 140 with a catalog including product identifiers used by the third party system 130 for various products. The catalog also includes characteristics associated with different products by the third party system 130. For example, the catalog includes a product identifier associated with a product by the third party system 130 as well as a title, a description, one or more keywords, and any other suitable information associated with the product identifier. Different third party systems 130 may provide the online system 140 with different characteristics associated with products. Hence, the online system 140 receives 310 information from one or more third party systems 130 describing products associated with the third party systems 130. The third party systems 130 can have overlapping product catalogs and, thus, the online system 140 often stores information for the same product being offered by two or more third party systems 130. In some embodiments, the online system 140 locally maintains information provided by a third party system 130 describing products associated with the third party system. For example, the online system 140 stores information describing products in association with an identifier of a third party system 130 that provided the information to the online system 140. Alternatively, the online system 140 retrieves information describing products from a third party system 130 associated with the products or providing the products.

The online system 140 also receives 410 a content item associated with a third party system 130 for presentation to one or more users of the online system 140 that includes a creative presenting content describing a product associated with a third party system 130. To increase a likelihood of users interacting with the content item when it is presented, the content item includes instructions that cause the online system 140 to select the product included in the creative and to generate the creative for the content item based on the selected product. Hence, rather than identify a specific product that is presented to each user to whom the content item is presented, the instructions included in the content item allow the online system 140 to dynamically identify the product presented by the creative for different users. This allows the online system 140 to present different content to different users via the content item, which increases a likelihood of the user interacting with the content item. Alternatively, each product could be associated with specific content item. The online system 140 may receive 410 the content item from the third party system 130 or may receive 410 the content item from another third party system 130 or from another entity.

With the product catalogs of multiple third party systems 130, the online system 140 compares 415 a price of the product being offered by a third party system 130 to one or more other prices for the product being offered by other third party systems 130. For example, the online system 140 compares 415 the product set from the third party system 130 to other products stored in content store 210 to identify similar and/or identical products being offered (e.g., sold, advertised, etc.) by other third party systems 130. The online system 140 performs a pricing analysis on the similar and/or identical products to determine how the price that each third party system 130 is charging for a product being offered compares to the price of the product being offered by the other third party systems 130.

FIG. 4B is a product price comparison diagram 450 that can be displayed to a third party system user, in accordance with an embodiment. For example, the online system 140 can determine whether the price of the third party's product is above or below an average price 465 being offered by the other third party systems and/or how far off their price 460 is from the average price 465. Accordingly, in this example, product price comparison can be provided in a UI for a third party system user to allow the third party system 130 to adjust their price for the product. Product price comparison diagram 450, in this example, shows a range of price values that includes a price maximum 455 or the highest price being charged for the product by other third party systems, and a price minimum 470 corresponding to the lowest price being charged for the product by other third party systems. In one example, product price comparison diagram 450 can show the product price 460 as red if it is below the average 465. In other examples, the colors represented in product price comparison diagram 450 could indicate how far away from the average price 465 the price 460 is for the third party system. In one embodiment, the online system 140 determines 420 a competitiveness value (or other metric that allows the price being offered by a first third party system to be compared to the price for the same or similar product being offered by another third party system) for the product offered by the third party system 130 relative to the one or more other prices for the product being offered by the other third party systems 130.

When the online system 140 identifies 425 an opportunity to present one or more content items to the user, the online system 140 retrieves 430 one or more candidate content items for the opportunity. In various embodiments, the one or more candidate content items can be retrieved based on characteristics of the user stored in a user profile of the user at the online system and based on products previously accessed by the user or accessed by other users of the online system 140 with characteristics of the products associated with the third party system 130. In various embodiments, the online system 140 identifies candidate products for a content item and in response to determining the content item is eligible for presentation to the user. The content item is eligible to be presented to the user if the characteristics of the user satisfy at least a threshold amount of targeting criteria included in the content item.

The online system 140 determines 435 a score for each of the retrieved candidate content items including the content item based at least in part on the characteristics of the user matching the criteria for presenting the content item. Based on various criteria, the content selection module 230 selects one or more of the content items identified as candidate content items for presentation to the user. In various embodiments, the score of each candidate content item is used at least in part to select the content item for the presentation opportunity. In one embodiment, a bid provided with the content item is used with the score for content item to determine the rank of the content item relative to other candidate content items. Accordingly, in one embodiment, the content item with the highest rank is selected for the presentation opportunity. Other criteria and methods can additionally or alternatively be used to score, rank, and select a content item for the presentation opportunity.

Accordingly, the online system adjusts 440 the score of the content item based on the competitiveness value for the product. As described above, the online system 140 may receive compensation from the third party system 130 each time a content item provided by the third party system 130 is displayed to a user on the online system 140 or each time another user is presented with a content item on the online system 140 and interacts with the content item (e.g., selects a link included in the content item), or each time another user performs another action after being presented with the content item. A content item describing a product with a low price compared to the price of the product being offered by other third party systems 130 is more likely to receive more attention and interaction from users compared to a content item describing the same product offered at a higher price. Since the online system 140 receives compensation from the third party system 130 for receiving user interaction with the content item, the online system may increase the score of the content item to increase the competitiveness of the content item in the selection process performed by the content selection module 230. Thus, the competiveness value increases the score of the content item relative to other candidate content items. Thus, a high competitiveness value may increase the rank of a content item relative to other candidate content items in a selection process and a low competitiveness value may decrease the rank of a content item relative to other candidate content items in a selection process. In one embodiment, the competitiveness may only increase the rank of a content item or decrease the rank of the content item relative to other content items. In one embodiment, the competiveness value is proportionate to a deviation of the price for the product being offered by the third party system 130 relative to an average price of the product being offered by the other third party systems 130.

Accordingly, the online system 140 selects 445 the content item having the creative including content describing the selected product for presentation to the user and provides the content item describing the selected product to a client device 110 associated with the user for presentation. For example, if the content item describing the product has at least a threshold measure of relevance or a has at least a threshold likelihood of obtaining an interaction by the user, the online system 140 selects 345 and provides the content item to a client device 110 for presentation to the user. As another example, if the content item describing the product is associated with a bid amount, one or more selection processes determine expected values to the online system 140 of presenting various content items based on bid amounts included in the content items and likelihoods of the user interacting with the content items. The one or more selection processes rank the content items by their expected values, and the online system 140 selects 445 the content item has at least a threshold position in the ranking.

In various embodiments, the content item also includes a landing page specifying a network address for obtaining additional information about the product. For example, the landing page specifies a network address of a web page maintained by the third party system 130 for purchasing the product via the third party system 130. If the user selects or otherwise accesses the content item, the client device 110 retrieves the additional information about the product from the specified network address.

### Determining an Optimal Price for a Product for Display in a Content Item to a Particular User of the Online System

FIG. 5 flowchart of one embodiment of a method for determining a price for a product based on a user of the online system 140 being presented a content item describing the product. In other embodiments, the method may include different and/or additional steps than those shown in FIG. 5. Additionally, steps of the method may be performed in different orders than the order described in conjunction with FIG. 5 in various embodiments.

As described with respect to FIG. 4A, the online system 140 obtains 505 product data from a third party system 130 describing characteristics of a product being offered by the third party system 130. The product data includes a price associated with the product. Various third party systems 130 provide the online system 140 with information describing products associated with the third party systems 130, such as products offered for sale or otherwise provided by the one or more third party systems 130. The online system 140 also receives 510 a content item associated with a third party system 130 for presentation to one or more users of the online system 140 that includes a creative presenting content describing a product associated with a third party system 130. In one embodiment, the creative is a template that includes one or more placeholder components that are replaceable with information describing the product. Selecting content and generating a content item based on a template that includes placeholder components is further described in U.S. patent application Ser. No. 14/085,998, filed on Nov. 21, 2013, which is hereby incorporated by reference in its entirety.

The online system 140 additionally receives 515 a particular goal or objective of an ad campaign including one or more constraints associated with the goal from the third party system 130. For example, the third party system 130 can specify that they want to sell X amount of money of product Y in Z amount of time. Accordingly, this allows the online system 140 to keep any amount of compensation exceeding X amount as profit. In this example, the goal is X amount of compensation and the constraints are that the product is product Y and that this amount of compensation is received for product Y in Z time. In one embodiment, the goal is a revenue goal corresponding to an aggregate amount of money received in exchange for the product. Accordingly, the goal allows the online system 140 the flexibility to dynamically determine a price for the product for each individual user at the time the content item describing the product is presented to the user.

In response to identifying 520 an opportunity to present the content item, the online system accesses product engagement data for the user and determines a likelihood of the user interacting with the content item for the product based on the accessed product engagement data for the user identifying the previously accessed products of the user. Using the goal, constraints, and the likelihood of the user interacting with the content item, price determination module 240 of the online system 140 determines 525 an optimal price for the product being described in the content item to allow the third party system 130 to meet the specified goal. Thus, in one embodiment, the optimal price is determined as a function of a probability of a particular user selecting the content item describing the product based on the user's engagement with other similar products. In addition to the product engagement data, the price determination module 240 may consider one or more of following when determining the probability: product attributes (e.g., expensive product may allow for a longer consideration cycle), price sensitivity (e.g., high price sensitivity for cheaper products relative to more expense products), time of day of the presentation opportunity, the particular user to whom the content item is being presented to (per impression based dynamic pricing), and user features and engagement data (e.g., past purchases, user's affinity for the product, how many times have they seen the content item, has the user seen the content item and x-ed it out before, pixel fires, etc.). Accordingly, the price determination module 240 uses this information to determine a likelihood of the user selecting or converting on the content item and determines 525 the optimal price for the product based on the likelihood of conversion and the goal of the third party system 130 for the ad campaign. In one embodiment, the online system 140 sets its own goal for the ad campaign and builds this additional goal into the determined optimal price. For example, the additional goal could be an additional percent markup of the offered price of the product as compensation for presenting the content item to users of the online system 140.

Accordingly, the online system determines a price for the product for the user based on the goal, the one or more constraints, and the determined likelihood of the user interacting with the content item for the product and replaces a placeholder component of the creative for the content item with a price component. The online system 140 provides 530 the content item including the creative describing the product with an offer to purchase the product at the determined optimal price for the product for display to the user. The price for the product shown in the content item displayed to the user is, thus, individually adjusted for each user based on user features and engagement data to optimize the conversion rate of the content item. Accordingly, the online system 140 receives 535 an interaction with the content item corresponding to the user selecting the offer to purchase the product at the determined optimal price via the content item. In response to receiving 535 the interaction to the content item, the online system 140 sends 545 the user and offer data corresponding to the determined optimal price for the product to a landing page for the product at the third party system 130. In one embodiment, the landing page at the third party system 130 displays the offer to purchase the product at the optimal price determined by the online system 140. Thus, the method for determining a price for a product described with respect to FIG. 5 includes an agreement between the online system 140 and the third party system 130 that the third party system 130 provides the product for sale at the price determined by the online system 140. Accordingly, when the user is sent 545 to the landing page of the third party system 130, the third party system updates the price for the product display on the landing page for the product based on the offer data received from the online system 140.

### Determining an Offer Format for a User of the Online System

The online system 140 determines an optimal pricing format (e.g., $1,600, $300 off, 25% off, etc.) for a product being described in a content item for each user. The optimal price format for a particular user is determined based on user features and engagement data (e.g., offer formats associated with past purchases, how many times has the user seen the a particular offer format and/or the product with the particular offer format, have they x-ed out content items with a particular offer format more often than others, etc.), and so forth. The system then generates a creative for the content item that includes the determined optimal price format for the product. Accordingly, at impression time, the format of the price shown in the content item is selected for the user. Thus, the offer format for a product could be different for a first user relative to second user while each offer format ultimately reflects the same price of the product (i.e., the same numerical offer is phrased in a different format).

FIG. 6 is a flowchart of a method for determining an offer format to present to a user in a content item for a product based on past engagement of the user with content items having one or more different offer formats, in accordance with an embodiment. In other embodiments, the method may include different and/or additional steps than those shown in FIG. 6. Additionally, steps of the method may be performed in different orders than the order described in conjunction with FIG. 6 in various embodiments.

As described with respect to FIG. 4A, the online system 140 obtains 605 product data from a third party system 130 describing characteristics of a product being offered by the third party system 130. The product data includes a price associated with the product. Various third party systems 130 provide the online system 140 with information describing products associated with the third party systems 130, such as products offered for sale or otherwise provided by the one or more third party systems 130. The online system 140 also receives 610 a content item associated with a third party system 130 for presentation to one or more users of the online system 140 that includes a creative presenting content describing a product associated with a third party system 130. In one embodiment, the creative presenting content describing the product includes instructions to select an offer format for the price of the product from multiple different offer formats. To increase a likelihood of users interacting with the content item when it is presented, the creative includes a field for an offer associated with the product that is populated with dynamic information for the offer as the content item is presented to a user of the online system. The dynamic information for the offer populated into the field of the creative is an offer format corresponding to one of multiple offer formats (e.g., $1,600, $300 off, 25% off, etc.) for the product.

When the online system 140 identifies 615 an opportunity to present a content item to a user of the online system 140, the content selection module 230 of the online system 140 accesses 620 product engagement data for the user. In one embodiment, the product engagement data identifies products previously accessed by the user, whether the user purchased the previously accessed product, an offer format of a plurality of offer formats associated with the previously accessed products, and so forth. Based on the accessed product engagement data, the online system 140 identifies 625 one or more candidate products of the products for which the online system 130 received information from the third party system 130 associated with the content item based on the products accessed by the user or accessed by other users of the online system 140 and characteristics of the products associated with the third party system 130. In various embodiments, the online system 140 identifies 625 candidate products in response to determining the content item is eligible for presentation to the user. The content item is eligible to be presented to the user if the user is associated with characteristics satisfying at least a threshold amount of targeting criteria included in the content item or if the content item does not include targeting criteria.

To identify 625 candidate products, the online system 140 compares characteristics of products associated with one or more third party systems 130 accessed by the user to characteristics of products associated with the third party system 130 and identifies 625 candidate products as one or more products associated with the third party system 130 having at least a threshold amount (e.g., at least a threshold number or at least a threshold percentage) of characteristics matching characteristics of products accessed by the user. For example, the online system 140 determines products included in content accessed by the user from the received information describing content or products accessed by the user, obtains characteristics of the determined products, and identifies 625 products associated with the third party system 130 that have at least a threshold amount of characteristics matching characteristics of the determined products as candidate products. As another example, the online system 140 extracts keywords, topics, or other information from content accessed by the user and identifies 625 candidate products as products associated with the third party system 130 that have at least the threshold amount of characteristics matching the extracted keywords, topics, or other information.

From the candidate products, the online system 140 selects 630 a product and an offer format for the creative of the content item. To select the product, the online system 140 determines likelihoods of the user interacting with content including each of at least a set of the candidate products. For example, the online system 140 generates different content items that each include a candidate product and determines likelihoods of the user interacting with each of the generated content items. To determine a likelihood of the user interacting with a generated content item, the online system 140 applies one or more models to characteristics of the user and to characteristics of the generated content item. The one or more models are based on prior interactions by the user with previously presented content items. Based on the determined likelihoods, the online system 140 selects 630 a candidate product.

Similarly, to select the offer format for product, the content selection module 230 determines likelihoods of the user interacting with the different offer formats based on prior interactions by the user with previously presented offer formats. In one embodiment, content selection module 230 determines a likelihood of the user interacting with each of the different offer formats by determining a frequency of each offer format type associated with a first set of offer formats associated with products that the user accessed, but did not purchase and determining a frequency of each offer format type associated with a second set of offer formats associated with products that the user accessed and purchased. In response to determining whether there is an offer format type that is more numerously associated with products that the user purchased over products that the user did not purchase, the content selection module 230 selects the offer format type associated with products that the user purchased for inclusion into the creative of the content item.

Further, the online system 140 selects 630 a candidate product and an offer format included in a generated content item with which the user had a maximum likelihood of interacting. In other embodiments, the online system 140 selects 630 a candidate product included in a generated content item having at least a threshold likelihood of interaction. As another example, the online system 140 ranks the determined products based on likelihoods of the user interacting with generated content items including the determined products and selects 630 a candidate a product included in a generated content item having at least a threshold position in the ranking. In other embodiments, the online system 140 selects 630 a candidate product associated with the third party system 130 matching a product previously accessed by the user. For example, the online system 140 selects 630 a candidate product associated with the third party system 130 that the user previously accessed at least a threshold number of times or selects 630 a candidate product associated with the third party system 130 that the user previously accessed within a threshold amount of time from a time when the online system 140 identified the opportunity to present one or more content items to the user.

The online system 140 generates 635 a creative for the content item including content describing the selected product with the selected offer format. For example, the online system 140 requests information describing the selected product from the third party system 130 and generates 635 the creative for the content item based on the requested information with selected offer format. As another example, the online system 140 retrieves a subset of the information about the content item previously received by the online system 140 and generates 635 the creative of the content item that includes the subset of the information. This allows the online system 140 to personalize the creative of the content item for the user by generating 635 the creative of the content item based on the content item and offer format selected 630 for the user, increasing a likelihood of the user interacting with or accessing the content item by having the content item describe a product in which the user is likely to have an interest while also being presented with an offer format communicating information of the offer that may be most influential to the user. In one embodiment, the plurality of offer formats for the price of the product include a percentage discount of the price, a total amount being subtracted from the price corresponding to the percentage discount, or a new price corresponding to the percentage discount subtracted from the price. Thus, each of the different offer formats corresponds to a different representation of the price being charged for the product by the third party system 130.

Accordingly, to select content for presentation to the user, the online system 140 includes the content item having the creative of the content item including content about the selected product in one or more selection processes selecting content for presentation to the user. Examples of selection processes used by the online system 140 to select content for presentation to the user are further described above in conjunction with FIG. 2. For example, a selection process determines a likelihood of the user interacting with various content items, or a measure of relevance of various content items to the user, based on characteristics of the user and characteristics of the content items. Hence, including the content about the selected product in the creative of the content item affects the likelihood of the user interacting with the content item or the measure of relevance of the content item to the user, which affects whether one or more of the selection processes select the content item to the user. As the online system 140 identifies 625 the candidate products based on content previously accessed by the user and selects 630 the selected product based on a likelihood of the user interacting with content including information about the selected product, having content describing the selected product in the creative of the content item increases a likelihood of the user interacting with the content item or increases a measure of relevance of the content item to the user, affecting evaluation of the content item by the one or more selection processes.

If the online system 140 selects 640 the content item having the creative including content describing the selected product and selected offer format for presentation to the user, the online system 140 communicates 645 the content item having the creative including content describing the selected product to a client device 110 associated with the user for presentation. For example, if the content item having the creative including content describing the selected product and selected offer format has at least a threshold measure of relevance or a hast least a threshold likelihood of obtaining an interaction by the user, the online system 140 selects 640 and communicates 345 the content item having the creative including content describing the selected product to a client device 110 for presentation to the user. As another example, if the content item having the creative including content describing the selected product is associated with a bid amount, one or more selection processes determine expected values to the online system 140 of presenting various content items based on bid amounts included in the content items and likelihoods of the user interacting with the content items. The one or more selection processes rank the content items by their expected values, and the online system 140 selects 640 the content item having the creative including content describing the selected product if the content item having the creative including content describing the selected product has at least a threshold position in the ranking.

In various embodiments, the content item having the creative including content describing the selected product and the selected offer format also includes a landing page specifying a network address for obtaining additional information about the selected product. For example, the landing page specifies a network address of a web page maintained by the third party system 130 for purchasing the selected product via the third party system 130. If the user selects or otherwise accesses the content item having the creative including content describing the selected product, the client device 110 retrieves the additional information about the selected product from the specified network address. In one embodiment, the online system 140 send offer data to the third party system corresponding to the selected offer format to allow the third party system to present the additional information about the selected product with the selected offer format on the landing page of the third party system 130.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, product data describing characteristics of a product being offered by a third party system;
receiving, at the online system, a content item for presentation to one or more users of the online system, the content item being associated with a goal and one or more constraints and including a creative presenting content describing the product, the creative including one or more placeholder components
identifying, by the online system, an opportunity to present a content item to a user of the online system;
responsive to identifying the opportunity to present the content item,
accessing product engagement data for the user, the engagement data identifying previously accessed products of the user;
determining a likelihood of the user interacting with the content item for the product based on the accessed product engagement data for the user identifying the previously accessed products of the user; and
determining, for the third party system, a price of the product for the user based on the goal, the one or more constraints, and the determined likelihood of the user interacting with the content item for the product;
replacing, by the online system, a placeholder component of the creative for the content item with a price component for the determined price of the product for the user determined based at least in part on the determined likelihood of the user interacting with the content item for the product; and
providing, for display on a client device of the user, the content item including the creative presenting the content describing the product and an offer to purchase the product at the determined price.

2. The method of claim 1, further comprising:
receiving, from the client device of the user, an interaction with the content item corresponding to the user selecting the offer to purchase the product at the determined price; and
sending, by the online system, the user and offer data corresponding to the determined price for the product to a landing page for the product at the third party system, the landing page at the third party system displaying the offer to purchase the product at the price determined by the online system.

3. The method of claim 1, wherein the goal is a revenue goals corresponding to a total monetary value being received for the product from conversions via the content item.

4. The method of claim 1, wherein the determined price of the product for the user is different relative to at least one other user of the online system based on a different likelihood of the at least one other user interacting with the content item for the product.

5. The method of claim 1, wherein the product data further describes characteristics of a plurality of other products being offered by the third party system and the online system, responsive to identifying the opportunity to present the content item further,
identifies one or more candidate products of the plurality of other products including the product associated with the third party system for presentation to the user of the online system based on the accessed product engagement data for the user identifying the previously accessed products of the user and characteristics of the products associated with the third party system; and
selects the product of the candidate products based on likelihoods of the user accessing each of at least a set of the candidate products.

6. The method of claim 5, further comprising:
replacing, by the online system, an additional placeholder component of the one or more placeholder components of the creative for the content item with the product selected from the at least a set of the candidate products based on the likelihoods of the user accessing each of the at least a set of the candidate products.

7. The method of claim 5, wherein identifying the one or more candidate products of the products comprises:
retrieving characteristics of at least a set of the products offered by the third party system;
determining characteristics of products provided by the third party system accessed by the user of the online system from the received information; and
identifying candidate products as products from the at least the set of the products that have at least a threshold amount of characteristics matching characteristics of the products associated with the third party system accessed by the user.

8. A method comprising:
obtaining, at an online system, product data describing characteristics of a product being offered by a third party system;
receiving, at the online system, a content item for presentation to one or more users of the online system, the content item including a creative presenting content describing the product;
receiving, from the third party system, a goal for the ad campaign and one or more constraints;
identifying an opportunity to present one or more content items to a user of the online system;
determining, for the third party system, a price of the product for the user based on the goal, the one or more constraints associated with the content item, and a likelihood of the user interacting with the content item for the product;
providing, for display on a client device of the user, the content item including the creative presenting the content describing the product and an offer for the product at the determined price;
receiving, from the client device of the user, an interaction with the content item corresponding to the user selecting the offer at the determined price; and
sending, by the online system, the user and offer data corresponding to the determined price for the product to a landing page for the product at the third party system.

9. The method of claim 8, wherein the price for the product is specific to the user and different relative to at least one other user of the online system.

10. The method of claim 8, wherein the price of the product is different for the user relative to the at least one other user of the online system based on a different likelihood of the at least one other user interacting with the content item for the product relative to the user.

11. The method of claim 8, wherein the landing page at the third party system displays the offer to purchase the product at the price determined by the online system.

12. The method of claim 8, wherein the goal corresponds to a total monetary value being received for the product from conversions via the content item.

13. A non-transitory computer-readable storage medium having instructions that, when executed by a processor, cause the processor to:
receive, at an online system, product data describing characteristics of a product being offered by a third party system;
receive, at the online system, a content item for presentation to one or more users of the online system, the content item being associated with a goal and one or more constraints and including a creative presenting content describing the product, the creative including one or more placeholder components identify, by the online system, an opportunity to present a content item to a user of the online system;
access product engagement data for the user, the engagement data identifying previously accessed products of the user;
determine a likelihood of the user interacting with the content item for the product based on the accessed product engagement data for the user identifying the previously accessed products of the user;
determine, for the third party system, a price of the product for the user based on the goal, the one or more constraints, and the determined likelihood of the user interacting with the content item for the product;
replace, by the online system, a placeholder component of the creative for the content item with a price component for the determined price of the product for the user determined based at least in part on the determined likelihood of the user interacting with the content item for the product; and
provide, for display on a client device of the user, the content item including the creative presenting the content describing the product and an offer to purchase the product at the determined price.

14. The non-transitory computer-readable storage medium of claim 13, wherein the instructions, that when executed from the processor, further cause the processor to:
receive, from the client device of the user, an interaction with the content item corresponding to the user selecting the offer to purchase the product at the determined price; and
send, by the online system, the user and offer data corresponding to the determined price for the product to a landing page for the product at the third party system, the landing page at the third party system displaying the offer to purchase the product at the price determined by the online system.

15. The non-transitory computer-readable storage medium of claim 13, wherein the determined price of the product for the user is different relative to at least one other user of the online system based on a different likelihood of the at least one other user interacting with the content item for the product.

16. The non-transitory computer-readable storage medium of claim 13, wherein the product data further describes characteristics of a plurality of other products being offered by the third party system and the online system, responsive to identifying the opportunity to present the content item further,
identifies one or more candidate products of the plurality of other products including the product associated with the third party system for presentation to the user of the online system based on the accessed product engagement data for the user identifying the previously accessed products of the user and characteristics of the products associated with the third party system; and
selects the product of the candidate products based on likelihoods of the user accessing each of at least a set of the candidate products.

17. The non-transitory computer-readable storage medium of claim 16, wherein identifying the one or more candidate products of the products comprises:
retrieving characteristics of at least a set of the products offered by the third party system;
determining characteristics of products provided by the third party system accessed by the user of the online system from the received information; and
identifying candidate products as products from the at least the set of the products that have at least a threshold amount of characteristics matching characteristics of the products associated with the third party system accessed by the user.

18. The non-transitory computer-readable storage medium of claim 16, wherein the instructions, that when executed from the processor, further cause the processor to:
replace, by the online system, an additional placeholder component of the one or more placeholder components of the creative for the content item with the product selected from the at least a set of the candidate products based on the likelihoods of the user accessing each of the at least a set of the candidate products.

19. The non-transitory computer-readable storage medium of claim 13, wherein the goal is a revenue goals corresponding to a total monetary value being received for the product from conversions via the content item.

20. The non-transitory computer-readable storage medium of claim 13, wherein the determined price of the product for the user is different relative to at least one other user of the online system based on a different likelihood of the at least one other user interacting with the content item for the product.
